(19) United States
(12) Patent Application Publication
(10) Pub. No.: US 2006/0097120 A1
(43) Pub. Date: May 11, 2006

(54) Charge cradle and mouse in combination

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/982,835

(22) Filed: Nov. 8, 2004

(51) Int. Cl. B68G 5/00

(52) U.S. Cl. 248/311.2

(57) ABSTRACT

A charge cradle and a mouse in combination have a clamping slot formed in a bottom of the mouse, a base of the charge cradle and a clamping member. The clamping member is made of resilient materials, and the clamping member is exposed out of the base and is received inside the clamping slot in order to abut against the clamping slot of the mouse. The clamping member of the charge cradle is retained against the clamping slot of the mouse, so as to form an engagement mechanism between the mouse and the charge cradle.

### BACKGROUND OF THE INVENTION

1. Field of the Invention

The present invention relates to a charge cradle and a mouse in combination, and particularly relates to a matching charge cradle and mouse, providing stable charge and excellent combination.

2. Background of the Invention

Along with the wide use of computers, increasing numbers of peripherals with wires are in use, as well. Some cables are so long that the cables interfere with each other and create a mess. The use of a mouse with a wire is restricted due to the length of the connection wire; a wireless mouse is thus provided. With reference to FIG. 1, a conventional wireless mouse 5 is disclosed in TW Patent Application Number 520777. A charge cradle 6 mating with the conventional wireless mouse 5 includes a charge slot 61, a receiver disposed on the charge cradle 6, and a conductive pad 62 arranged on an inner surface of the charge cradle 61. The conductive pad 62 is in direct contact with the mouse 5 for electrical connection.

This mouse charging method uses the weight of the mouse 5 on the charge cradle 6, so that the conductive pad 62 makes contact with a conductive member of the mouse 5. In fact, the mouse 5 and the charge cradle 6 contact poorly, because of the tilt of the charge cradle 6 or the mouse 5, incorrect placement of the mouse 5, or separation between the mouse 5 and the charge cradle 6 due to external reasons. These bad contacts lead to bad charge quality of the mouse 5, or, in the worst case, no recharge of the mouse 5. The recharge process will not only waste the user's time, but also make trouble in an emergency. Furthermore, a charge cradle 6 that conducts electricity without actually recharging the mouse 5 is very dangerous.

### SUMMARY OF INVENTION

The primary objective of the invention is therefore to specify a charge cradle-and a mouse in combination, which match each other for a stable charge and excellent combination.

The secondary objective of the invention is therefore to specify a charge cradle and a mouse in combination, which can maintain excellent connection and alignment therebetween while in motion.

According to the invention, these objectives are achieved by a charge cradle and a mouse in combination, which includes a clamping slot formed in a bottom of the mouse, a base of the charge cradle and a clamping member. The clamping member is made of resilient materials, and the clamping member is exposed by the base and is received inside the clamping slot in order to abut against the clamping slot of the mouse. The clamping member of the charge cradle is retained against the clamping slot of the mouse, so as to form an engagement mechanism between the mouse and the charge cradle.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of a conventional wireless mouse and a charge cradle;

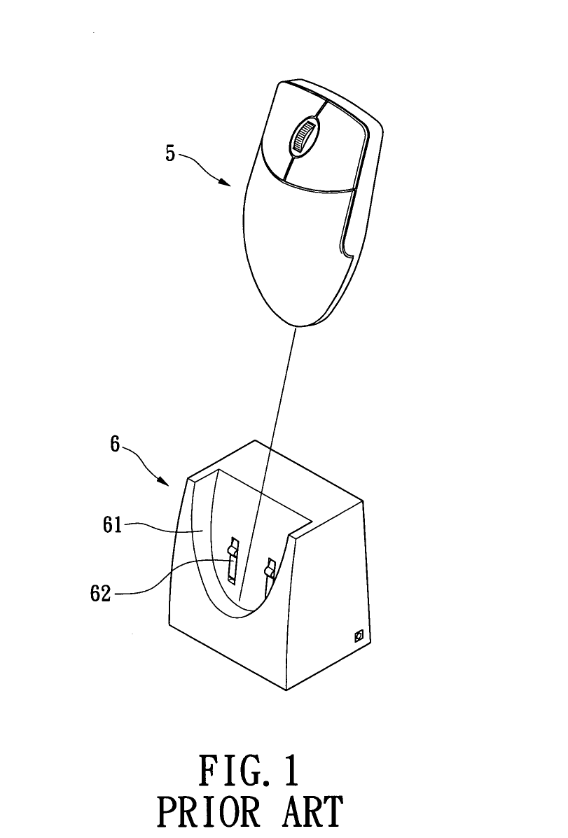

FIG. 2 is a perspective view of a charge cradle and a mouse in combination according to the present invention;

FIG. 3 is a perspective view of the charge cradle according to the first embodiment of the present invention;

FIG. 4 is a perspective view of the mouse according to the present invention; and

FIG. 5 is a perspective view of the charge cradle according to the second embodiment of the present invention.

### DETAILED DESCRIPTION OF THE EMBODIMENTS

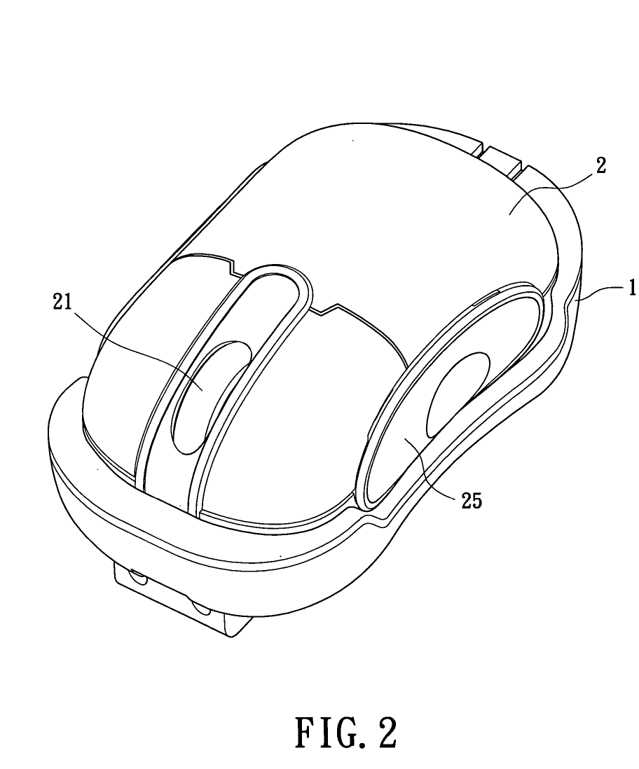

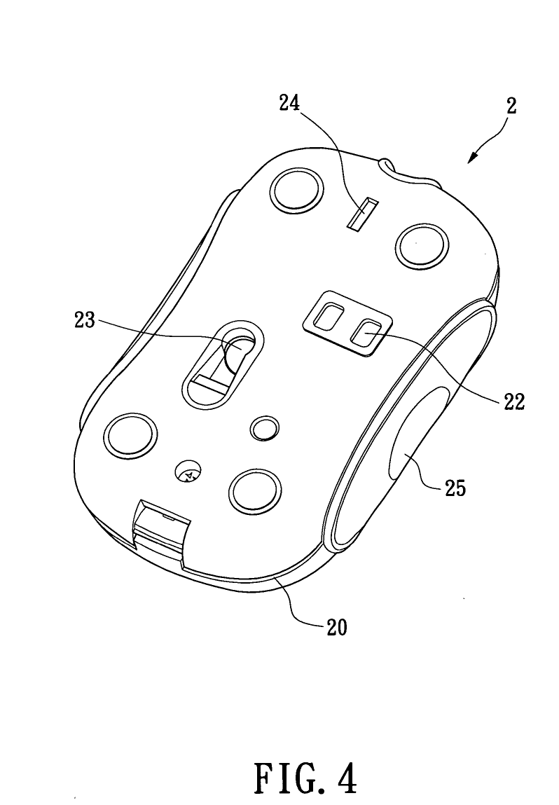

With respect to FIGS. 2 and 4, a charge cradle 1 and a mouse 2 in combination are disclosed according to the present invention. The mouse 2 includes a body 20, a front roller 21 arranged at a top of a front of the body 20, a conductive pad 22 disposed on a bottom of the body 20 for electrically connecting the charge cradle 1, a main roller 23 exposed partially from the bottom of the body 20, and a clamping slot 24 formed at the bottom of the body 20. The charge cradle 1 includes a base 10 having an inner surface 101 that is flat for directly loading the mouse 2 or concave so as to serve as a chargeable recess 102 for receiving the mouse 2. The base 10 includes a resilient contact 103 for electrically connecting the conductive pad 22 of the mouse 2. The base 10 includes a clamping member 12, which is made of resilient materials and exposed by the base 10. The shape of the clamping member 12 varies according to requirements, and clamping member 12 is received inside the clamping slot 24 to abut against the clamping slot 24 of the mouse 2. The clamping member 12 of the charge cradle 2 is retained against the clamping slot 24 of the mouse 2 to form an engagement mechanism between the mouse 2 and the charge cradle 1. The clamping member 12 includes a head portion 123 protruding outwardly for firm retention against the mouse 2. When the mouse 2 suppresses the charge cradle 1, the clamping member 12 is forced against a circumstance surrounding the clamping slot 24 outwardly until the head portion 123 is inserted inside the clamping slot 24. Thus, the mouse 2 is engaged with the charge cradle 1 via the head portion 123, so that the alignment between the mouse 2 and the charge cradle 1 can be guaranteed for an excellent connection. Furthermore, the charge cradle 1 carried with the mouse 2 can be moved during the recharge process. In addition, the mouse 2 can be removed or taken up by forcing the mouse 2 in the direction of the clamping member 12.

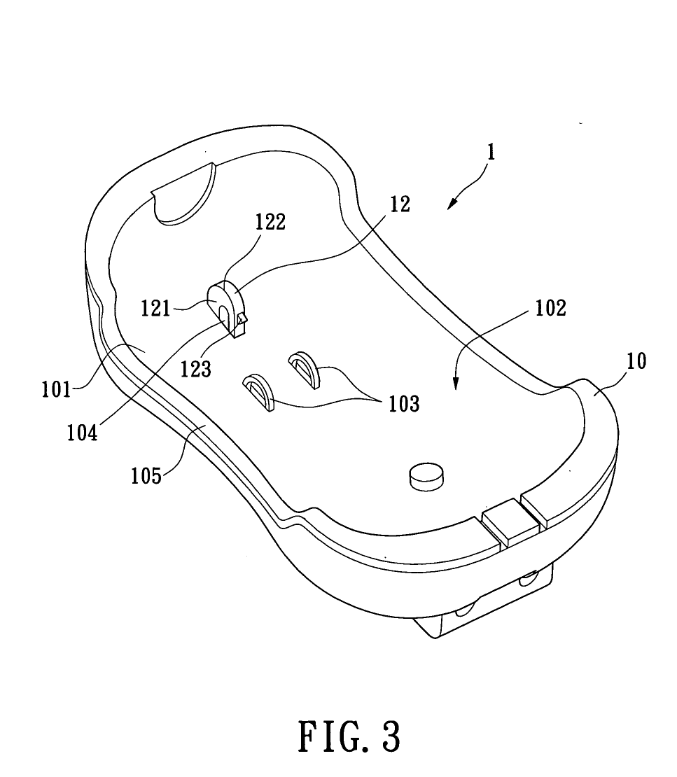

According to an embodiment illustrated in FIG. 3, the clamping member f2 is U-shaped. The clamping member 12 includes two resilient arms 121 abutting outwardly and laterally from the base 10, and an arched section 122 arranged between the two resilient arms 121. The two resilient arms 121 are received inside the clamping slot 24 and the arched section 122 is exposed outwardly from the base 10. The head portion 123 can be disposed on a respective one of the two resilient arms 121 for a further connection. When the mouse 2 suppresses the charge cradle 1, the clamping member 12 can be squeezed inwardly and provides a recovery force to abut against the clamping slot 24. The clamping member 12 is put into the clamping slot 24 gradually until the head-portion 123 is inserted inside the clamping slot 24; a guaranteed connection is thus provided. The charge cradle 1 with the mouse 2 can be moved or carried easily. The base 10 of the charge cradle 1 has a slit 104 from which the clamping member 12 is outwardly exposed (or the arched section 122 is exposed out of the slit 104). Selectively, the clamping member 12 extends outwardly from the base 10 (or one of the two resilient arms 121 extends from the base 10 integrally and the other separates from the base 10).

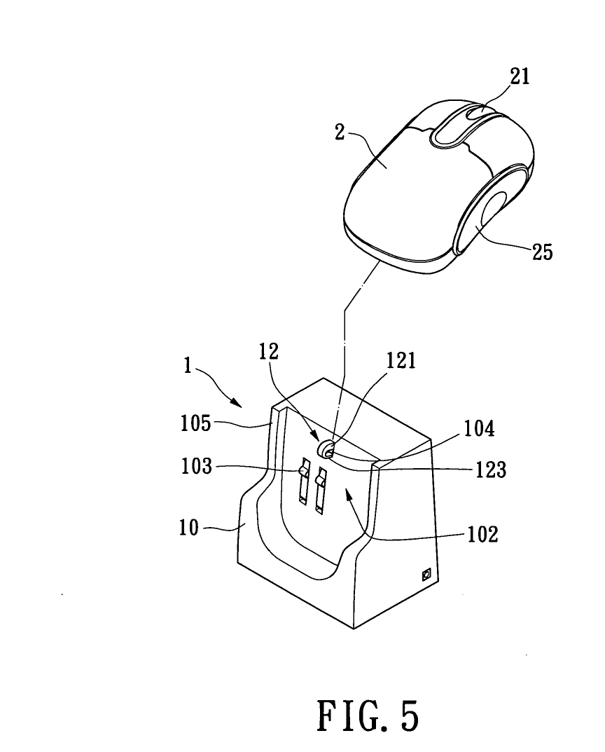

The clamping slot 24 of the mouse 2 can be formed at any position of the bottom thereof. The base 10 of the charge cradle 1 can be horizontal or upright. Therefore, the clamping slot 24 can be formed at a front of the base of the mouse 2, and the clamping member 12 is relative to the clamping slot 24, especially when the charge cradle 1 is in the upright type (in FIG. 5). With reference to FIGS. 3 and 6, the base 20 of the mouse 2 includes a finger mark indent 25 formed at each lateral side thereof, and the base 10 of the charge cradle 1 has a side camber 105 concaved at each lateral side of an inner surface thereof, while the charge cradle 1 is with the chargeable recess 102. The side camber 105 is relative to the finger mark indent 25. Of course, the finger mark indent 25 also can be formed when the charge cradle is provided without the chargeable recess 102.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A charge cradle and a mouse in combination, comprising:
a clamping slot formed in a bottom of the mouse;
a base of the charge cradle; and
a clamping member made of resilient materials and exposed out of the base, the clamping member being received inside the clamping slot in order to abut against the clamping slot of the mouse;
whereby the clamping member of the charge cradle is retained against the clamping slot of the mouse, so as to form an engagement mechanism between the mouse and the charge cradle.

2. The charge cradle and a mouse in combination as claimed in claim 1, wherein the base has a slit and the clamping member is exposed outwardly from the slit.

3. The charge cradle and a mouse in combination as claimed in claim 1, wherein the clamping member extends outwardly from the base.

4. The charge cradle and a mouse in combination as claimed in claim 1, wherein the clamping member includes a head portion protruding outwardly.

5. The charge cradle and a mouse in combination as claimed in claim 1, wherein the clamping member is U-shaped, the clamping member includes two resilient arms outwardly and laterally abutting the base and an arched section arranged between the two resilient arms, and the two resilient arms are received inside the clamping slot and the arched section is outwardly exposed from the base.

6. The charge cradle and a mouse in combination as claimed in claim 1, wherein the mouse includes a body, a front roller arranged at a top of a front of the body, a conductive pad disposed on a bottom of the body for electrically connecting to a resilient contact of the charge cradle, and a main roller exposed partially from the bottom of the body, wherein the clamping slot is formed at the bottom of the body.

7. The charge cradle and a mouse in combination as claimed in claim 1, wherein the charge cradle has a chargeable recess formed in the base for receiving the mouse.

8. The charge cradle and a mouse in combination as claimed in claim 7, wherein the mouse includes a finger mark indent formed in each lateral side thereof, and the base of the charge cradle has a side camber concaved in each lateral side of an inner surface thereof, the side camber being relative to the finger mark indent.

9. The charge cradle and a mouse in combination as claimed in claim 1, wherein the clamping slot is formed in a front of the mouse, and the clamping member is relative to the clamping slot.

10. The charge cradle and a mouse in combination as claimed in claim 1, wherein the base of the charge cradle is horizontal or upright.
